(19) United States
(12) Patent Application Publication
(10) Pub. No.: US 2008/0318791 A1
(43) Pub. Date: Dec. 25, 2008

(54) Use of Lactate Esters for Improving the Action of Agricultural Pesticides

(75) Inventors: Peter Baur, Schondorf (DE); Lorna Elizabeth Davies, Kansas City, MO (US); Rolf Pontzen, Leichlingen (DE); Andreas Rochling, Langenfeld (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer Cropscience Aktiengesellschaft, Monheim (DE)

(21) Appl. No.: 12/066,040

(22) PCT Filed: Aug. 31, 2006
(86) PCT No.: PCT/EP2006/008513

§ 371 Date: Jul. 22, 2008

(30) Foreign Application Priority Data
Sep. 9, 2005 (DE) 10 2005 042 876.2

(51) Int. Cl. A01N 37/36; A01P 21/00

(52) U.S. Cl. 504/307

(57) ABSTRACT

Use of lactate esters of the formula (I)

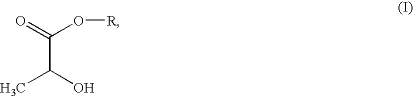

in which R represents straight-chain or branched saturated or unsaturated C₄-C₈-alkyl, for improving the activity of crop protection compositions at plant level.

The invention relates to the use of lactate esters in crop protection compositions for improving the activity at plant level.

WO 91/14366 describes lactate and lactate derivatives as active compounds which regulate the growth of grapevines. Here, the substances are, in a fixed dosage without further additives, made up directly in water and used as a foliar spray solution at an early growth stage of the grapevines. This document neither discloses nor suggests the use of lactate derivatives for improving the activity of crop protection compositions at plant level.

WO 00/18227 describes highly concentrated alkyl lactates as suspending agents for insoluble agrochemically active compounds in non-aqueous suspension concentrates. This document neither discloses nor suggests the use of alkyl lactates for improving the activity at plant level.

WO 03/075657 describes highly concentrated lactate esters as crystallization inhibitors and solvents for insoluble agrochemically active compounds, in particular azole fungicides. This document neither discloses nor suggests the use of lactate esters for improving the activity at plant level.

WO 96/22020 describes the use of aliphatic esters as penetration enhancers. This application also discloses lactate esters; however, the esters according to the invention are not embraced by the formula disclosed therein. The lactate esters that are disclosed differ considerably in their structure from the esters according to the invention. This document neither discloses nor suggests the use of the lactate esters according to the invention and the improvement of the retention of spray liquors by lactate esters.

Surprisingly, it has now been found that the activity of crop protection compositions at plant level is improved significantly by certain lactate esters. Thus, the lactate esters according to the invention enhance both the retention of the spray liquor of the crop protection compositions according to the invention on the plant, in particular the leaves (improved retention), and also penetration of the agrochemically active compounds present in the crop protection compositions into the plant (improved penetration). This improvement of the properties is achieved even at concentrations of lactate esters where these do not yet act as solvents. Here, it is furthermore particularly advantageous that lactate esters are ecologically acceptable.

Accordingly, the invention provides the use of lactate esters of the formula (I)

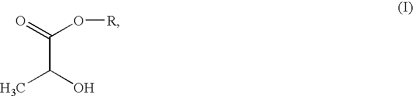

in which
R represents straight-chain or branched saturated or unsaturated C₁-C₈-alkyl
for improving the activity of crop protection compositions at plant level.

The formula (I) provides a general definition of the lactate esters suitable for the use according to the invention. Preferred radical definitions of the formulae mentioned above and below are indicated below:
R preferably represents straight-chain or branched saturated or unsaturated C₄-C₈-alkyl.
R particularly preferably represents straight-chain or branched saturated or unsaturated C₆-C₈-alkyl.
R very particularly preferably represents straight-chain or branched saturated octyl.
R especially preferably represents 1-ethylhexyl, 2-ethylhexyl, 3-ethylhexyl, 4-ethylhexyl, 1-methylheptyl, 2-methylheptyl, 3-methylheptyl, 4-methylheptyl, 5-methylheptyl, 6-methylheptyl or n-octyl.

Emphasis is given to the compound of the formula (I) in which R represents 2-ethylhexyl.

The compounds of the formula (I) are employed individually or in the form of mixtures. If, in the description or the claims, lactate esters are referred to, this explicitly means individual compounds according to the invention or mixtures of a plurality of compounds according to the invention.

The lactate esters of the formula (I) are known and commercially available, or they can be prepared by generally known methods.

If appropriate, the lactate esters used according to the invention can be present as mixtures of various possible isomeric forms, in particular of stereoisomers, such as, for example, E and Z, threo and erythro, and also optical isomers. What is claimed is the use of any isomeric forms and of mixtures of isomeric forms. Preference is given to using L-lactate derivatives of the formula (I).

Depending on the active compound and the formulation type, the amount of one or more compounds of the formula (I) in the use according to the invention in crop protection compositions can vary within wide limits. The compounds of the formula (I) can be used in all customary agrochemical formulations, preferably in liquid formulations. The present invention also provides the use of the lactate esters of the formula (I) for improving the activity at plant level as a tank mix additive, i.e. the lactate esters are added only immediately prior to application of a spray liquor prepared from a concentrated formulation. However, in principle, the compounds can also be incorporated into solid formulations.

The use according to the invention of lactate esters of the formula (I) is carried out, for example, in ready-to-use crop protection compositions (spray liquors) in which the content of one or more lactate esters of the formula (I) is
from 0.01 to 3% (weight/volume),
particularly preferably from 0.01 to 1% (weight/volume),
very particularly preferably from 0.02 to 0.5% (weight/volume),
especially preferably from 0.03 to 0.3% (weight/volume).

If a crop protection composition comprises a plurality of lactate esters, the stated amount is to be understood as total content of all lactate esters.

The present invention provides the use of lactate esters of the formula (I) for improving the activity of crop protection compositions at plant level by improved penetration of agrochemically active compounds in plants.

The present invention provides the use of lactate esters of the formula (I) for improving the activity of crop protection compositions at plant level by improved retention of crop protection compositions on plants, in particular on leaves.

The general or preferred radical definitions, ranges of values or illustrations listed above can also be combined with one another as desired, i.e. between the respective ranges and preferred ranges.

Since, in principle, the mechanism of action of the lactate esters as penetration enhancers is independent of the nature of the agrochemically active compound used, they can be used in crop protection compositions comprising at least one active compound whose biological activity can be improved by increased penetration into a crop plant or harmful plant.

Since, in principle, the mechanism of action of the lactate esters as retention enhancers is likewise independent of the nature of the agrochemically active compound used, they can be used in crop protection compositions comprising at least one active compound whose biological activity can be increased by improved retention on the crop plant or harmful plant.

Fungicides, bactericides, insecticides, acaricides, nematicides, herbicides, plant growth regulators, plant nutrients and repellents may be mentioned as being preferred.

Examples of fungicides which may be mentioned are

Inhibitors of nucleic acid synthesis
benalaxyl, benalaxyl-M, bupirimate, chiralaxyl, clozylacon, dimethirimol, ethirimol, furalaxyl, hymexazol, mefenoxam, metalaxyl, metalaxyl-M, ofurace, oxadixyl, oxolinic acid

Inhibitors of mitosis and cell division
benomyl, carbendazim, diethofencarb, ethaboxam, fuberidazole, pencycuron, thiabendazole, thiophanate-methyl, zoxamide

Inhibitors of respiratory chain complex I
diflumetorim

Inhibitors of respiratory chain complex II
boscalid, carboxin, fenfuram, flutolanil, furametpyr, furmecyclox, mepronil, oxycarboxin, penthiopyrad, thifluzamide

Inhibitors of respiratory chain complex III
azoxystrobin, cyazofamid, dimoxystrobin, enestrobin, famoxadone, fenamidone, fluoxastrobin, kresoxim-methyl, metominostrobin, orysastrobin, pyraclostrobin, picoxystrobin, trifloxystrobin

Decouplers
dinocap, fluazinam

Inhibitors of ATP production
fentin acetate, fentin chloride, fentin hydroxide, silthiofam

Inhibitors of amino acid biosynthesis and protein biosynthesis
andoprim, blasticidin-S, cyprodinil, kasugamycin, kasugamycin hydrochloride hydrate, mepanipyrim, pyrimethanil

Inhibitors of signal transduction
fenpiclonil, fludioxonil, quinoxyfen

Inhibitors of lipid and membrane synthesis
chlozolinate, iprodione, procymidone, vinclozolin
ampropylfos, potassium-ampropylfos, edifenphos, etridiazole, iprobenfos (IBP), isoprothiolane, pyrazophos
tolclofos-methyl, biphenyl
iodocarb, propamocarb, propamocarb hydrochloride propamocarbfosetylate

Inhibitors of ergosterol biosynthesis
fenhexamid,
azaconazole, bitertanol, bromuconazole, cyproconazole, diclobutrazole, difenoconazole, diniconazole, diniconazole-M, epoxiconazole, etaconazole, fenarimol, fenbuconazole, fluquinconazole, flurprimidol, flusilazole, flutriafol, furconazole, furconazole-cis, hexaconazole, imazalil, imazalil sulphate, imibenconazole, ipconazole, metconazole, myclobutanil, nuarimol, oxpoconazole, paclobutrazole, penconazole, pefurazoate, prochloraz, propiconazole, prothioconazole, pyrifenox, simeconazole, tebuconazole, tetraconazole, triadimefon, triadimenol, triflumizole, triforing, triticonazole, uniconazole, voriconazole, viniconazole,
aldimorph, dodemorph, dodemorph acetate, fenpropidin, fenpropimorph, spiroxamine, tridemorph,
naftifine, pyributicarb, terbinafine

Inhibitors of cell wall synthesis
benthiavalicarb, bialaphos, dimethomorph, flumorph, iprovalicarb, mandipropamid, polyoxins, polyoxorim, validamycin A

Inhibitors of melanin biosynthesis
carpropamid, diclocymet, fenoxanil, phthalide, pyroquilon, tricyclazole

Resistance induction
acibenzolar-5-methyl, probenazole, tiadinil

Multisite
captafol, captan, chlorothalonil, copper salts such as: copper hydroxide, copper naphthenate, copper oxychloride, copper sulphate, copper oxide, oxine-copper and Bordeaux mixture, dichlofluanid, dithianon, dodine, dodine free base, ferbam, folpet, fluorofolpet, guazatine, guazatine acetate, iminoctadine, iminoctadine albesilate, iminoctadine triacetate, mancopper, mancozeb, maneb, metiram, metiram zinc, propineb, sulphur and sulphur preparations containing calcium polysulphide, thiram, tolylfluanid, zineb, ziram

Further fungicides
amibromdol, benthiazole, bethoxazin, capsimycin, carvone, chinomethionat, chloropicrin, cufraneb, cyflufenamid, cymoxanil, dazomet, debacarb, diclomezine, dichlorophen, dicloran, difenzoquat, difenzoquat methylsulphate, diphenylamine, ferimzone, flumetover, flusulfamide, fluopicolide, fluoroimide, fosetyl-aluminium, fosetyl-calcium, fosetyl-sodium, hexachlorobenzene, 8-hydroxyquinoline sulphate, irumamycin, methasulphocarb, metrafenone, methyl isothiocyanate, mildiomycin, natamycin, nickel dimethyl dithiocarbamate, nitrothal-isopropyl, octhilinone, oxamocarb, oxyfenthiin, pentachlorophenol and salts, 2-phenylphenol and salts, piperalin, propanosine-sodium, proquinazid, pyribencarb, pyrrolnitrin, quintozene, tecloftalam, tecnazene, triazoxide, trichlamide, valiphenal zarilamid,
2-(2-{[6-(3-chloro-2-methylphenoxy)-5-fluoropyrimidine-4-yl]oxy}phenyl)-2-(methoxyimino)-N-methylacetamide,
2-[[[[1-[3-(1-fluoro-2-phenylethyl)oxy]phenyl]ethylidene]amino]oxy]methyl-alpha-(methoxyimino)-N-methyl-alpha-benzacetamide,
cis-1-(4-chlorophenyl)-2-(1H-1,2,4-triazol-1-yl)cycloheptanol,
1-[(4-methoxyphenoxy)methyl]-2,2-dimethylpropyl-1H-imidazole-1-carboxylic acid,
2,3,5,6-tetrachloro-4-(methylsulfonyl)pyridine,
2-butoxy-6-iodo-3-propylbenzopyranon-4-one,
2-chloro-N-(2,3-dihydro-1,1,3-trimethyl-1H-inden-4-yl)-3-pyridinecarboxamide,
3,4,5-trichloro-2,6-pyridinedicarbonitrile,
3,4-dichloro-N-(2-cyanophenyl)isothiazole-5-carboxamide (isotianil)
3-[5-(4-chlorophenyl)-2,3-dimethylisoxazolidin-3-yl]pyridine,
5-chloro-6-(2,4,6-trifluorophenyl)-N-[(1R)-1,2,2-trimethylpropyl][1,2,4]triazolo[1,5-a]-pyrimidine-7-amine,
5-chloro-7-(4-methylpiperidin-1-yl)-6-(2,4,6-trifluorophenyl)[1,2,4]triazolo[1,5-a]pyrimidine,
5-chloro-N-[(1R)-1,2-dimethylpropyl]-6-(2,4,6-trifluorophenyl) [1,2,4]triazolo[1,5-a]-pyrimidine-7-amine,
methyl 2-[[[cyclopropyl-[(4-methoxyphenyl)imino]methyl]thio]methyl]-alpha-(methoxymethylene)benzacetate,
methyl 1-(2,3-dihydro-2,2-dimethyl-1H-inden-1-yl)-1H-imidazole-5-carboxylate,
N-(3′,4′-dichloro-5-fluorobiphenyl-2-yl)-3-(difluoromethyl)-1-methyl-1H-pyrazole-4-carboxamide,
N-(3-ethyl-3,5,5-trimethylcyclohexyl)-3-formylamino-2-hydroxybenzamide,
N-(4-chloro-2-nitrophenyl)-N-ethyl-4-methylbenzenesulphonamide,
N-(4-chlorobenzyl)-3-[3-methoxy-4-(prop-2-yn-1-yloxy)phenyl]propanamide,
N-[(4-chlorophenyl)(cyano)methyl]-3-[3-methoxy-4-(prop-2-yn-1-yloxy)phenyl]-propanamide,
N-(5-bromo-3-chloropyridin-2-yl)methyl-2,4-dichloronicotinamide,
N-[1-(5-bromo-3-chloropyridin-2-yl)ethyl]-2,4-dichloronicotinamide,
(2S)—N-[2-[4-[[3-(4-chlorophenyl)-2-propynyl]oxy]-3-methoxyphenyl]ethyl]-3-methyl-2-[(methylsulphonyl)amino]butanamide,
N-{(Z)-[(cyclopropylmethoxy)imino][6-(difluoromethoxy)-2,3-difluorophenyl]methyl}-2-benzacetamide,
N-{2-[1,1′-bi(cyclopropyl)-2-yl]phenyl}-3-(difluoromethyl)-1-methyl-1H-pyrazole-4-carboxamide,
N-{2-[3-chloro-5-(trifluoromethyl)pyridin-2-yl]ethyl}-2-(trifluoromethyl)benzamide,
N-ethyl-N-methyl-N′-{2-methyl-5-(trifluoromethyl)-4-[3-(trimethylsilyl)propoxy]phenyl}-imidoformamide,
O-[1-[(4-methoxyphenoxy)methyl]-2,2-dimethylpropyl]1H-imidazole-1-carbothioic acid,
2-amino-4-methyl-N-phenyl-5-thiazolecarboxamide,
2,4-dihydro-5-methoxy-2-methyl-4-[[[[1-[3-(trifluoromethyl)phenyl]ethylidene]amino]oxy]-methyl]phenyl]-3H-1,2,4-triazol-3-one (CAS No. 185336-79-2),
N-(6-methoxy-3-pyridinyl)cyclopropanecarboxamide,

Examples of bactericides which may be mentioned are:

bronopol, dichlorophen, nitrapyrin, nickel dimethyldithiocarbamate, kasugamycin, octhilinone, furancarboxylic acid, oxytetracycline, probenazole, streptomycin, tecloftalam, copper sulphate and other copper preparations.

Examples of insecticides, acaricides and nematicides which may be mentioned are:

Acetylcholine esterase (AChE) inhibitors
Carbamates,
for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulphan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, triazamate
Organophosphates,
for example acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-S-methyl, demeton-S-methylsulphon, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion

Sodium channel modulators/voltage-dependent sodium channel blockers
Pyrethroids,
for example acrinathrin, allethrin (d-cis-trans, d-trans), beta-cyfluthrin, bifenthrin, bioallethrin, bioallethrin-5-cyclopentyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans-isomer), prallethrin, profluthrin, protrifenbute, pyresmethrin, resmethrin, RU 15525, silafluofen, tau-fluvalinate, tefluthrin, terallethrin, tetramethrin (1R isomer), tralomethrin, transfluthrin, ZXI 8901, pyrethrins (pyrethrum)
DDT
Oxadiazines,
for example indoxacarb
Semicarbazone,
for example metaflumizon (BAS3201)

Acetylcholine receptor agonists/antagonists
Chloronicotinyls,
for example acetamiprid, clothianidin, dinotefuran, imidacloprid, nitenpyram, nithiazine, thiacloprid, thiamethoxam
Nicotine, bensultap, cartap

Acetylcholine receptor modulators
Spinosyns,
for example spinosad

GABA-controlled chloride channel antagonists
Organochlorines,
for example camphechlor, chlordane, endosulfan, gamma-HCH, HCH, heptachlor, lindane, methoxychlor
Fiprols,
for example acetoprole, ethiprole, fipronil, pyrafluprole, pyriprole, vaniliprole

Chloride channel activators
Mectins,
for example abamectin, emamectin, emamectin-benzoate, ivermectin, lepimectin, milbemycin

Juvenile hormone mimetics,
for example diofenolan, epofenonane, fenoxycarb, hydroprene, kinoprene, methoprene, pyriproxifen, triprene

Ecdysone agonists/disruptors
Diacylhydrazines,
for example chromafenozide, halofenozide, methoxyfenozide, tebufenozide

Chitin biosynthesis inhibitors
Benzoylureas,
for example bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron
Buprofezin
Cyromazine

Oxidative phosphorylation inhibitors, ATP disruptors
Diafenthiuron
Organotin compounds,
for example azocyclotin, cyhexatin, fenbutatin-oxide

Oxidative phosphorylation decouplers acting by interrupting the H-proton gradient
Pyrroles,
for example chlorfenapyr
Dinitrophenols,
for example binapacryl, dinobuton, dinocap, DNOC, meptyldinocap

Site-I electron transport inhibitors
METIs,
for example fenazaquin, fenpyroximate, pyrimidifen, pyridaben, tebufenpyrad, tolfenpyrad
Hydramethylnon
Dicofol

Site-II electron transport inhibitors
Rotenone

Site-III electron transport inhibitors
Acequinocyl, fluacrypyrim

Microbial disruptors of the insect gut membrane
Bacillus thuringiensis strains

Lipid synthesis inhibitors
Tetronic acids,
for example spirodiclofen, spiromesifen,
Tetramic acids,
for example spirotetramat, cis-3-(2,5-dimethylphenyl)-4-hydroxy-8-methoxy-1-azaspiro[4.5]dec-3-en-2-one
Carboxamides,
for example flonicamid
Octopaminergic agonists,
for example amitraz

Inhibitors of magnesium-stimulated ATPase,
Propargite
Nereistoxin analogues,
for example thiocyclam hydrogen oxalate, thiosultap-sodium

Ryanodine receptor agonists,
Benzodicarboxamides,
for example flubendiamide
Anthranilamides,
for example Rynaxypyr (3-bromo-N-{4-chloro-2-methyl-6-[(methylamino)carbonyl]-phenyl)}-1-(3-chloropyridin-2-yl)-1H-pyrazole-5-carboxamide)

Biologicals, hormones or pheromones
azadirachtin, Bacillus spec., Beauveria spec., codlemone, Metarrhizium spec., Paecilomyces spec., thuringiensin, Verticillium spec.

Active compounds with unknown or unspecific mechanisms of action
Fumigants,
for example aluminium phosphide, methyl bromide, sulphuryl fluoride
Antifeedants,
for example cryolite, flonicamid, pymetrozine
Mite growth inhibitors,
for example clofentezine, etoxazole, hexythiazox
Amidoflumet, benclothiaz, benzoximate, bifenazate, bromopropylate, buprofezin, chinomethionat, chlordimeform, chlorobenzilate, chloropicrin, clothiazoben, cycloprene, cyflumetofen, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyridalyl, sulfluramid, tetradifon, tetrasul, triarathene, verbutin

Examples of herbicides which may be mentioned are:

Anilides such as, for example, diflufenican and propanil; arylcarboxylic acids such as, for example, dichloropicolinic acid, dicamba and picloram; aryloxyalkanoic acids such as, for example, 2,4-D, 2,4-DB, 2,4-DP, fluoroxypyr, MCPA, MCPP and triclopyr; aryloxyphenoxy-alkanoic esters, such as, for example, diclofop-methyl, fenoxaprop-ethyl, fluazifop-butyl, haloxyfop-methyl and quizalofop-ethyl; azinones, such as, for example, chloridazon and norflurazon; carbamates such as, for example, chlorpropham, desmedipham, phenmedipham and propham; chloroacetanilides such as, for example, alachlor, acetochlor, butachlor, metazachlor, metolachlor, pretilachlor and propachlor; dinitroanilines such as, for example, oryzalin, pendimethalin and trifluralin; diphenyl ethers such as, for example, acifluorfen, bifenox, fluoroglycofen, fomesafen, halosafen, lactofen and oxyfluorfen; ureas such as, for example, chlortoluron, diuron, fluometuron, isoproturon, linuron and methabenzthiazuron; hydroxylamines such as, for example, alloxydim, clethodim, cycloxydim, sethoxydim and tralkoxydim; imidazolinones such as, for example, imazethapyr, imazamethabenz, imazapyr and imazaquin; nitriles such as, for example, bromoxynil, dichlobenil and ioxynil; oxyacetamides such as, for example, mefenacet; sulphonylureas such as, for example, amidosulfuron, bensulfuron-methyl, chlorimuron-ethyl, chlorsulfuron, cinosulfuron, metsulfuron-methyl, nicosulfuron, primisulfuron, pyrazosulfuron-ethyl, thifensulfuron-methyl, triasulfuron and tribenuron-methyl; thiocarbamates such as, for example, butylate, cycloate, di-allate, EPTC, esprocarb, molinate, prosulfocarb, thio-bencarb and tri-allate; triazines such as, for example, atrazin, cyanazin, simazin, simetryne, terbutryne and terbutylazin; triazinones such as, for example, hexazinon, metamitron and metribuzin; others such as, for example, aminotriazole, 4-amino-N-(1,1-dimethylethyl)-4,5-dihydro-3-(1-methylethyl)-5-oxo-1H-1,2,4-triazole-1-carboxamide, benfuresate, bentazone, cinmethylin, clomazone, clopyralid, difenzoquat, dithiopyr, ethofumesate, fluorochloridone, glufosinate, glyphosate, isoxaben, pyridate, quinchlorac, quinmerac, sulphosate and tridiphane.

Examples of plant growth regulators which may be mentioned are chlorcholine chloride, thidiazuron and ethephon. Moreover auxins including the synthetic auxins, such as NAA, 2,4-D, gibberellic acid, cytokinines, including the synthetic cytokinines, such as benzyladenine, kinetin, abscissic acid, salicylic acid, jasmonic acid and their esters, and brassinosteroids.

Examples of plant nutrients which may be mentioned are conventional inorganic or organic fertilizers for providing plants with macronutrients and/or micronutrients.

Examples of repellents which may be mentioned are diethyltolylamide, ethylhexanediol and butopyronoxyl.

Preferred examples of fungicides are the strobilurin fungicides such as, for example

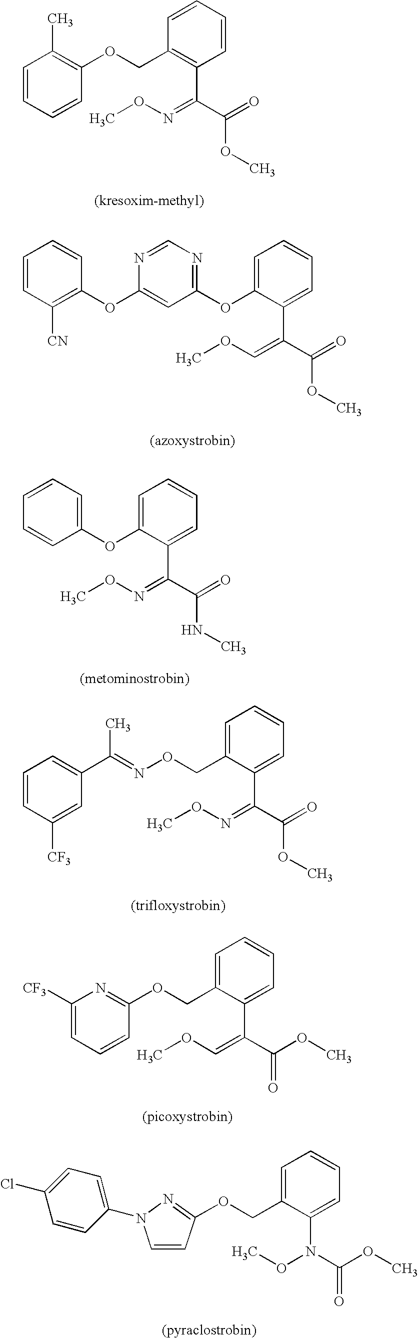

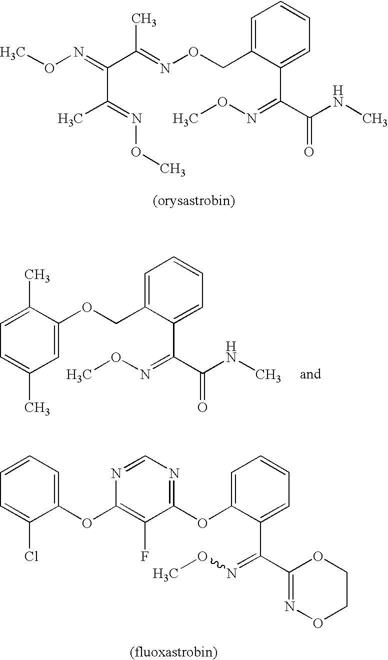

and the azole fungicides such as

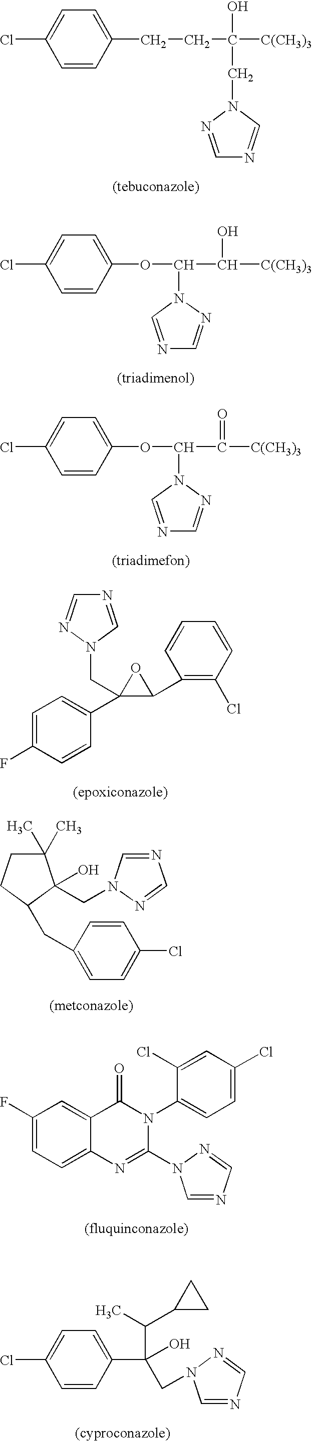

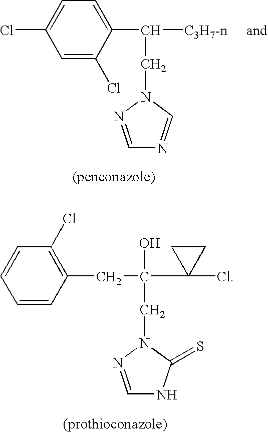

Preferred examples of fungicides which may be mentioned are prothioconazole, fluoxastrobin, trifloxystrobin, spiroxamine and tebuconazole.

The formulation types which are suitable include all formulations which are applied to plants or their propagation material. The methods used for preparing them are generally known to the skilled worker and for example described in Winnacker-Küchler, “Chemische Technologie” [Chemical Technology], volume 7, C. Hanser Verlag Munich, 4th edition, 1986; J. W. van Valkenburg, “Pesticide Formulations”, Marcel Dekker N.Y., 1973, K. Martens, “Spray Drying Handbook”, 3rd Ed. 1979, G. Goodwin Ltd., London, or Mollet, Grubenmann, “Formulierungstechnik” [Formulation Technology], Wiley-VCH-Verlag, Weinheim, 2000.

Examples of formulation types are all those mentioned in the “Manual on development and use of FAO and WHO specifications for pesticides” (FAO and WHO, 2002, appendix E) (in each case using the GCPF formulation codes with English abbreviation and name): AB Grain bait; AE Aerosol dispenser; AL Any other liquid; AP Any other powder; CF Capsule Suspension for Seed Treatment; CG Encapsulated granule; CL Contact liquid or gel; CP Contact powder; CS Capsule suspension; DC Dispersible concentrate; DP Dustable powder; DS Powder for dry seed treatment; DT Tablet for direct application; EC Emulsifiable concentrate; ED Electrochargeable liquid; EG Emulsifiable Granule; EO Emulsion, water in oil; EP emulsifiable powder, ES Emulsion for seed treatment; EW Emulsion, oil in water; FG Fine granule; FS Flowable concentrate for seed treatment; GF Gel for Seed Treatment; GG Macrogranule; GL Emulsifiable gel; GP Flo-dust; GR Granule; GS Grease; GW Water-soluble gel; HN Hot-fogging concentrate; KK Combi-pack solid/liquid; KL Combi-pack liquid/liquid; KN Cold-fogging concentrate; KP Combi-pack solid/solid; LA Lacquer; LS Solution for seed treatment; ME Microemulsion; MG Microgranule; OD oil dispersion, OF Oil-miscible flowable concentrate/oil-miscible suspension; OL Oil-miscible liquid; OP Oil-dispersible powder; PA Paste; PC Gel or paste concentrate; PO Pour-on; PR Plant rodlet; PS Seed coated with a pesticide; PT Pellet; RB Bait (ready for use); SA Spot-on; SC suspension concentrate, SD suspension concentrate for direct application, SE Suspo-emulsion; SG Water-soluble granule; SL Soluble concentrate; SO Spreading oil; SP Water-soluble powder; SS Water-soluble powder for seed treatment; ST Water-soluble tablet; SU Ultra-low volume (ULV) suspension; TB Tablet; TC Technical material; TK Technical concentrate; UL Ultra-low volume (ULV) liquid; VP Vapour-releasing product; WG Water-dispersible granules; WP Wettable powder; WS Water-dispersible powder for slurry seed treatment; WT Water-dispersible tablet; XX Others.

Liquid formulation types are preferred. These include the formulation types DC (GCPF formulation code for dispersible concentrate); EC (GCPF formulation code for emulsion concentrate); EW (GCPF formulation code for oil-in-water emulsion); ES (GCPF formulation code for emulsion for seed treatment), FS (GCPF formulation code for multiphase concentrate for seed treatment), EO (GCPF formulation code for water-in-oil emulsion; ME (GCPF formulation code for microemulsion; SE (GCPF formulation code for suspo-emulsion); SL (GCPF formulation code for soluble concentrate); CS (GCPF formulation code for capsule suspension) and AL (GCPF formulation code for ready-to-use liquid formulation).

Emulsion concentrates (formulation type EC) are particularly preferred for a use according to the invention of the lactate esters of the formula (I).

Suitable additives which may be present in the formulations according to the invention, preferably the liquid formulations according to the invention, are all customary formulation adjuvants such as organic solvents, antifoams, emulsifiers, dispersants, preservatives, acids and bases, colorants, fillers, penetration enhancers and also water.

Antifoams which are suitable are conventional antifoams which are present in formulations of agrochemically active compounds. Examples which may be mentioned are silicone oils, silicone oil dispersions, magnesium stearate, phosphinic and phosphonic acids, in particular Fluowet PL 80®.

Suitable organic solvents are all customary organic solvents which thoroughly dissolve the agrochemically active compounds employed. The following may be mentioned as being preferred: aliphatic and aromatic, optionally halogenated hydrocarbons such as toluene, xylene, Solvesso®, mineral oils such as white spirit, petroleum, alkylbenzenes and spindle oil, furthermore tetrachloromethane, chloroform, methylene chloride and dichloromethane, and furthermore esters such as ethyl acetate, furthermore lactones such as butyrolactone, moreover lactams such as N-methylpyrrolidone, N-octylpyrrolidone, N-dodecylpyrrolidone, and N-methylcaprolactam, and also alkanecarboxamides, such as N,N-dimethyldecanecarboxamide and N,N-dimethyloctanecarboxamide, γ-butyrolactone, and also dimethylformamide.

Suitable emulsifiers are conventionally used surfactants which are present in formulations of agrochemically active compounds. Examples which may be mentioned are ethoxylated nonylphenols, polyethylene glycol ethers of linear alcohols, reaction products of alkylphenols with ethylene oxide and/or propylene oxide, ethylene oxide/propylene oxide block copolymers, polyethylene glycols and polypropylene glycols, furthermore fatty acid esters, fatty acid polyglycol ether esters, alkylsulphonates, alkyl sulphates, aryl sulphates, ethoxylated arylalkylphenols such as, for example tristyryl phenol ethoxylate with an average of 16 ethylene oxide units per molecule, furthermore ethoxylated and propoxylated arylalkylphenols and sulphated or phosphated arylalkylphenol ethoxylates or -ethoxy- and -propoxylates. Especially preferred are tristyrylphenol alkoxylates and fatty acid polyglycol ether esters. Very especially preferred are tristyrylphenol ethoxylates, tristyrylphenol ethoxypropoxylates and castor oil polyglycol ether esters, in each case individually or in mixtures.

Dispersants which can be used are all substances which are conventionally employed in crop protection compositions for this purpose. In addition to the examples which are mentioned hereinabove as emulsifiers, the following may be mentioned by preference: natural and synthetic, water-soluble polymers such as gelatin, starch and cellulose derivatives, in particular cellulose esters and cellulose ethers, furthermore polyvinyl alcohol, polyvinylpyrrolidone, polyacrylic acid, polymethacrylic acid and copolymers of (meth)acrylic acid and (meth)acrylic esters, and furthermore alkali-metal-hydroxide-neutralized copolymers of methacrylic acid and methacrylic esters.

Preservatives which can be used are all substances which are conventionally present in crop treatment compositions for this purpose. Examples which may be mentioned are Preventol® and Proxel®.

Colorants which are suitable are all inorganic or organic colorants which are conventionally used for the preparation of crop protection compositions. Examples which may be mentioned are titanium dioxide, carbon black, zinc oxide and blue pigments.

Fillers which are suitable are all substances which are conventionally employed in crop protection compositions for this purpose. The following may be mentioned by preference: inorganic particles, such as carbonates, silicates and oxides with a mean particle size of from 0.005 to 5 μm, especially preferably from 0.02 to 2 μm. Examples which may be mentioned are silicon dioxide, what is known as highly dispersed silica, silica gels, and natural and synthetic silicates and alumosilicates.

Suitable compounds which act as emulsion stabilizers and/or crystallization inhibitors are all substances which are conventionally employed in crop protection compositions for this purpose.

Suitable penetration enhancers are, for example, alkanol alkoxylates of the formula (I)

R—O—(-AO)ₘ—R′ (I)

in which
R represents straight-chain or branched alkyl having 4 to 20 carbon atoms,
R′ represents H, methyl, ethyl, n-propyl, isopropyl, n-butyl, isobutyl, t-butyl, n-pentyl or n-hexyl,
AO represents an ethylene oxide radical, a propylene oxide radical, a butylene oxide radical or represents mixtures of ethylene oxide and propylene oxide radicals or represents mixtures of ethylene oxide and butylene oxide radicals and
m represents numbers from 2 to 30.

These substances are mixtures of compounds of the stated type having different chain lengths. Accordingly, average values, which may also deviate from integers, are calculated for the indices.

Suitable penetration enhancers are furthermore customary surfactants used in formulations of agrochemically active compounds. Examples which may be mentioned are ethoxylated nonylphenols, tributylphenol polyglycol ethers, reaction products of alkylphenols with ethylene oxide and/or propylene oxide, alkoxylated alkylamines, alkoxylated mono-, di- or triglycerides, polyethylene oxide sorbitan fatty esters, furthermore fatty acid polyglycol ether esters, diesters and diethers of polyalkylene oxides, fatty ester ethoxylates, and also alkyl ethoxylates and alkylaryl ethoxylates, which may be phosphatated and, if appropriate, neutralized with bases. Suitable anionic surfactants are furthermore all substances of this type which are customarily used in agrochemical compositions. Preference is given to alkali metal, ammonium and alkaline earth metal salts of alkylsulphonic acids or alkylarylsulphonic acids, and also to alkyl(poly)ethylene glycol ether sulphates or sulphonates. Non-surfactant penetration enhancers which may be mentioned are fatty acid esters, mono- and diesters of dicarboxylic acids and also phosphate esters.

The content of the individual components in the formulations according to the invention can be varied within a substantial range.

The preparation of the formulations according to the invention is accomplished for example in such a manner that the components are mixed with one another in the desired ratios in each case. If the agrochemically active compound is a solid, the latter is generally employed in finely ground form or in the form of a solution or suspension in an organic solvent or water. If the agrochemically active compound is liquid, the use of an organic solvent can frequently be dispensed with. Moreover, a solid agrochemically active compound may be employed in the form of a melt.

When carrying out the process, the temperatures can be varied within a certain range. In general, the process is carried out at temperatures of between 0° C. and 80° C., preferably between 10° C. and 60° C.

When carrying out the process according to the invention, a procedure is generally followed in which the lactate esters (I) are mixed with one or more active compounds and, if appropriate, with additives. The components can be mixed with one another in any order.

The equipment which is suitable for carrying out the process according to the invention is customary equipment which is employed for the preparation of agrochemical formulations.

Suitable application forms are all those methods which are known to the skilled worker as being conventionally used; examples which may be mentioned are: spraying, immersion, misting and a series of specific methods for the direct below- or above-ground treatment of whole plants or parts (seeds, root, stolons, stalks, stem, leaf), such as, for example, in the case of trees the injection into the stem or in the case of perennial plants stalk bands, and a series of specific indirect application methods.

The term “harmful organisms” embraces all forms of organisms causing economical and/or health damage in the respective area of use. Preference is given to vegetable and animal harmful organisms and also to organisms causing diseases, particular preference is given to terrestrial and aquatic weed grasses and broad-leaved weeds, algae, mosses, insects, mites, nematodes, rodents, fungi, bacteria and viruses.

The specific application rate of the crop protection compositions of a wide range of formulation types for controlling the abovementioned harmful organisms, either based on area and/or the object to be treated varies greatly. In general, the application media, which are known to the skilled worker as being conventionally used for the field of application in question, are employed in customary amounts, such as, for example, from several hundred litres of water per hectare in the case of standard spray methods to a few litres of oil per hectare in the case of ‘Ultra Low Volume’ aerial application to a few millilitres of a physiological solution in the case of injection methods. The concentrations of the crop protection compositions according to the invention in the relevant application media therefore vary within a wide range and depend on the specific field of application. In general, concentrations are used which are known to the skilled worker as being conventionally used for the specific field of application. Preferred concentrations are from 0.01% by weight to 99% by weight, especially preferred concentrations from 0.1% by weight to 90% by weight.

The crop protection compositions according to the invention, for example in the use forms which are conventional for liquid preparations, can be applied either as such or after previously having been diluted with water, that is to say for example as emulsions, suspensions or solutions. The application here is accomplished by customary methods, that is to say, for example, by spraying, pouring or injecting.

The application rate of the crop protection compositions according to the invention can be varied within a substantial range. It depends on the agrochemically active compounds in question and on their content in the crop protection compositions.

As regards the use of herbicides, the plants treated in accordance with the invention are all weed species. As regards the protection of crop plants by the application of, for example, fungicides and insecticides, the use in economically important, including, for example, transgenic, crops of useful plants and ornamentals, for example cereals such as wheat, barley, rye, oats, millet, rice, cassava and maize, or else crops of sugar beet, cotton, soya, oilseed rape, potato, tomato, pea and other vegetables is preferred.

The invention is illustrated in greater detail by the examples without being limited thereto.

### EXAMPLES

Additives which act as penetration enhancers at the level of the cuticle may be referred to below as accelerator additives (cf. Schönherr and Baur, 1994, Pesticide Science 42, 185-208). The feature of accelerator additives is their ability to penetrate from the aqueous spray liquor and/or from the spray covering into the cuticle and thereby to increase the mobility of the active compounds in the cuticle. Other additives such as polyethylene glycol, in contrast, only act on the spray covering (via the liquid phase) or act only as wetting agents, such as, for example, sodium dodecylsulphate.

This test determines the influence of additives on the penetration properties of other substances at the level of the cuticle. The mobility of a test substance in the cuticle is measured with and without an additive, by way of a desorption method. The method is published in detail in the literature (Baur et al., 1997, Pesticide Science, 51, 131-152) and only the principles and any deviations are described below.

As a test substance with the function of a tracer a selection was made here of a radiolabelled weak organic acid. Plant material used comprises the enzymatically isolated leaf cuticles of the top face of pear leaves from outdoor trees. The cuticles were installed in specially manufactured stainless steel diffusion cells. The tracer, in a citrate buffer at a pH of 3 in the dissolved state, was applied to the side originally facing the inside of the leaf. This inner side readily takes up the small radioactive amount of the tracer in the undissociated acid form. Subsequently this inner side was covered and maintained at 100% atmospheric humidity. The morphological outer side of the leaf cuticle, normally exposed to air, was then contacted with a buffer (pH 7), with the receptor solution, and the desorption was started. The penetrated acid form of the test substance is dissociated by the receptor and the desorption follows first-order kinetics. The desorption constant is proportional to the mobility of the tracer in the cuticle.

After at least two times for determining this constant, the desorption is then continued with a buffer which additionally includes the test additive. Depending on the property of the additive there is then sorption of the additive in the cuticle and, depending on its activity as a plasticizer for the cuticle, there is an increase in the mobility of the tracer within the cuticle. This is manifested in an increased desorption constant, and the ratio of the slopes with additive to that without additive describes the effect of the additive to act as a penetration enhancer at the level of the cuticle. The comparison of the average effect of different additives shows their effectiveness at acting as cuticle plasticizers.

As can be seen by the examples listed in Table 1,2-ethylhexyl lactate is very effective as a plasticizer. The alternative which was used to lactate ester (Genapol® X-060, Clariant, Sulzbach, Germany) is a commercially conventional penetration enhancer for formulations which is known to be effective, whereas Tween® 80 (Uniqema, Emmerich, Germany) has hardly any plasticizer properties.

TABLE 1

| | | Concentration | |
|---|---|---|---|
| Example | Additive | (g/l) | Mean effect |
| 1 | Tween ® 80 | 2 | 4 |
| 2 | Genapol ® X-060 | 1 | 42.3 |
| 3 | 2-Ethylhexyl lactate | 1 | 45 |

### Retention Test

Retention is to be understood as meaning the adherence of spray mists to surfaces, for example plants or plant parts (leaves), after spray application. The retention depends both on the composition of the spray liquor and on the nature of the treated surface.

The retention of a spray liquor (aqueous solution of the stated additive) was determined using a poorly wettable leaf in comparison to a reference surface with complete retention. The reported results were obtained using primary leaves of barley seedlings which had been cultivated in a greenhouse (18° C., 80% atmospheric humidity, 16 h of light). Individual cut leaves were subjected to standard treatment in a spray cabin using a track sprayer-flat-jet nozzle: XR 11002 VS; pressure: 3 bar; 3001/ha. Weight and leaf area were determined prior to the treatment, and the adhering spray coating was correspondingly determined gravimetrically and normalized to leaf area. A nonwoven-fabric paper cloth serves as reference surface for 100% retention. Per spray liquor variant, at least 5 individual leaves were treated, and the calculated retentions were then averaged. A test series where pure tap water as spray liquor was sprayed onto the barley seedling leaves was carried out as negative control (lowest retention).

At a concentration of 0.3 g/l (solubility limit in water in the absence of emulsifier), EHL increased the retention considerably. The added emulsifier (Pluronic® PE 10500, BASF, Ludwigshafen, Germany) had no effect on the retention.

TABLE 2

| | | Concentration | |
|---|---|---|---|
| Example | Additive | (g/l) | Retention |
| 1 | No additive | | 0% |
| 2 | Pluronic ® PE 10500 | 0.2 | 0.6% |
| 3 | 2-Ethylhexyl lactate | 0.3 | 60.6% |
| 4 | 2-Ethylhexyl lactate | 3 | 61% |
| | (+0.2 g/l Pluronic ® PE 10500) | | |

1. A method of improving the activity, retention, penetration, or a combination thereof of crop protection compositions at the plant level, comprising applying a lactate ester of the formula (I) 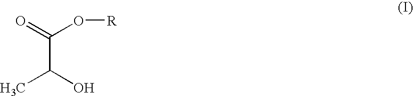
in which R represents straight-chain or branched saturated or unsaturated C₄-C₈-alkyl,
to crop plants in need of protection.

2. A composition for improving the activity, retention, penetration, or a combination thereof of crop protection compositions at the plant level comprising in total from 0.01 to 3% (weight/volume) of at least one lactate ester of formula (I) according to claim 1.

3. A method for improving the activity, retention, penetration, or a combination thereof of crop protection compositions when applying aqueous spray liquors, comprising adding at least one lactate ester of the formula (I) according to claim 1 to the spray liquors.
